(19) United States
(12) Patent Application Publication
(10) Pub. No.: US 2023/0292786 A1
(43) Pub. Date: Sep. 21, 2023

(54) PRODUCT DISPENSING MACHINE

(71) Applicant: TAYLOR COMMERCIAL FOODSERVICE, LLC, Rockton, IL (US)

(72) Inventor: James J. MINARD, Roscoe, IL (US)

(21) Appl. No.: 18/201,918

(22) Filed: May 25, 2023

Related U.S. Application Data
(63) Continuation of application No. 16/308,540, filed on Dec. 10, 2018, now abandoned.
(60) Provisional application No. 62/358,702, filed on Jul. 6, 2016.

(51) Int. Cl. A23G 9/28

(52) U.S. Cl. CPC A23G 9/28

(57) ABSTRACT

A product dispensing machine includes a container, a freeze circuit, a liquid circuit, a blending chamber assembly, and a dispensing assembly. The container stores a base product. The freeze circuit is constructed and arranged to extract a first portion of the base product from the container and substantially freeze the first portion into a first consistency. The liquid circuit is constructed and arranged to extract a second portion of the base product from the container. The blending chamber assembly is in fluid communication with the frozen and liquid circuits, and is constructed and arranged to blend the first and second portions into a second consistency. The dispensing assembly is in fluid communication with the blending chamber assembly, and is constructed and arranged to selectively dispense the first portion in the first consistency, and the first and second portions in the second consistency.

### CROSS-REFERENCE TO RELATED APPLICATIONS

This application is a continuation application of U.S. patent application Ser. No. 16/308,540, filed Dec. 10, 2018, which is a US national stage application under Section 371 of International Patent Application No. PCT/US2017/040868, filed Jul. 6, 2017, which claims priority from Provisional Patent Application No. 62/358,702, filed Jul. 6, 2016, which are each hereby fully incorporated by reference.

### BACKGROUND

The present disclosure relates to a product dispensing machine, and more particularly, to a dispensing machine for a product of human consumption.

Traditional product dispensing machines such as, for example, soft serve ice cream machines and shake machines typically require two different machines. More recent dispensing machines may include the ability to dispense two different products or two different product consistencies, however, internal to such machines remains a multitude of components similar in number to that of two machines. Unfortunately, such redundancies may lead to large machine footprints, high manufacturing costs and robustness and maintenance issues.

### SUMMARY

A product dispensing machine according to one, non-limiting, embodiment includes a container for storing a base product; a freeze circuit constructed and arranged to extract a first portion of the base product from the container and substantially freeze the first portion into a first consistency; a liquid circuit constructed and arranged to extract a second portion of the base product from the container; a blending chamber assembly in fluid communication with the frozen and liquid circuits, and constructed and arranged to blend the first and second portions into a second consistency; and a dispensing assembly in fluid communication with the blending chamber assembly, and constructed and arranged to selectively dispense the first portion in the first consistency, and the first and second portions in the second consistency.

Additionally to the foregoing embodiment, the product dispensing machine includes a refrigeration unit constructed and arranged to extract heat from the freeze circuit.

In the alternative or additionally thereto, in the foregoing embodiment, the refrigeration unit is constructed and arranged to control temperature of the base product in the container.

In the alternative or additionally thereto, in the foregoing embodiment, the freeze circuit includes a freezing cylinder defining a chamber in fluid communication between the container and the blending chamber assembly, and constructed and arranged to freeze the first portion via the refrigeration unit.

In the alternative or additionally thereto, in the foregoing embodiment, the freeze circuit includes a beater disposed in the freezing chamber for working the first portion.

In the alternative or additionally thereto, in the foregoing embodiment, the liquid circuit includes a pump for controlling the flow of the second portion to the blending chamber assembly.

In the alternative or additionally thereto, in the foregoing embodiment, the liquid circuit includes a temperature device configured to control the temperature of the second portion.

In the alternative or additionally thereto, in the foregoing embodiment, the liquid circuit includes a check valve for preventing flow of the base product from the blending chamber assembly back to the container.

In the alternative or additionally thereto, in the foregoing embodiment, the product dispensing machine includes a controller constructed and arranged to control the refrigeration unit; and a human interface constructed and arranged to select between the first and second consistencies of the base product for dispensing through the dispensing assembly.

In the alternative or additionally thereto, in the foregoing embodiment, the freeze circuit includes a freezing cylinder defining a chamber in fluid communication between the container and the blending chamber assembly and constructed and arranged to freeze the first portion via the refrigeration unit; a beater disposed in the freezing chamber for working the first portion; and a pump for flowing the first portion from the container to the freezing cylinder, wherein the pump is controlled by the controller.

In the alternative or additionally thereto, in the foregoing embodiment, the liquid circuit includes a flow control device for controlling the flow of the second portion to the blending chamber assembly; a temperature device configured to control the temperature of the second portion in the liquid circuit, wherein the temperature device is controlled by the controller; and a check valve for preventing flow of the base product from the blending chamber assembly and back to the container.

In the alternative or additionally thereto, in the foregoing embodiment, the base product is at least in-part a dairy product, the first consistency is a soft ice cream consistency, and the second consistency is a shake consistency.

In the alternative or additionally thereto, in the foregoing embodiment, the product dispensing machine includes a second container for storing an additive product; and an additive circuit constructed and arranged to flow the additive product from the second container and to the blending chamber assembly.

In the alternative or additionally thereto, in the foregoing embodiment, the additive product includes a syrup.

In the alternative or additionally thereto, in the foregoing embodiment, the dispensing assembly includes a single nozzle for dispensing both the first portion in the first consistency, and the first and second portions in the second consistency.

An ice cream dispensing machine according to another, non-limiting, embodiment includes a container for storing an base product; a freeze circuit constructed and arranged to extract a first portion of the base product from the container and substantially freeze the first portion into an ice cream consistency; a liquid circuit constructed and arranged to extract a second portion of the base product from the container; a blending chamber assembly in fluid communication with the frozen and liquid circuits, and constructed and arranged to blend the first and second portions into a shake consistency; and a dispensing assembly in fluid communication with the blending chamber assembly, and constructed and arranged to selectively dispense the first portion in the ice cream consistency, and the first and second portions in the shake consistency through a common nozzle of the dispensing assembly.

Additionally to the foregoing embodiment, the ice cream dispensing machine includes a refrigeration unit; and wherein the freeze circuit includes an evaporator of the refrigeration unit adapted to be a freezing cylinder defining a chamber in fluid communication between the container and the blending chamber assembly for freezing the first portion into the ice cream consistency.

In the alternative or additionally thereto, in the foregoing embodiment, the liquid circuit includes a temperature device configured to control the temperature of the second portion.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a perspective view of a product dispensing machine as one exemplary embodiment of the present disclosure;

FIG. 2 is a side view of the product dispensing machine with portions removed to show internal detail; and

FIG. 3 is a flow chart of a method of operating the product dispensing machine.

### DETAILED DESCRIPTION

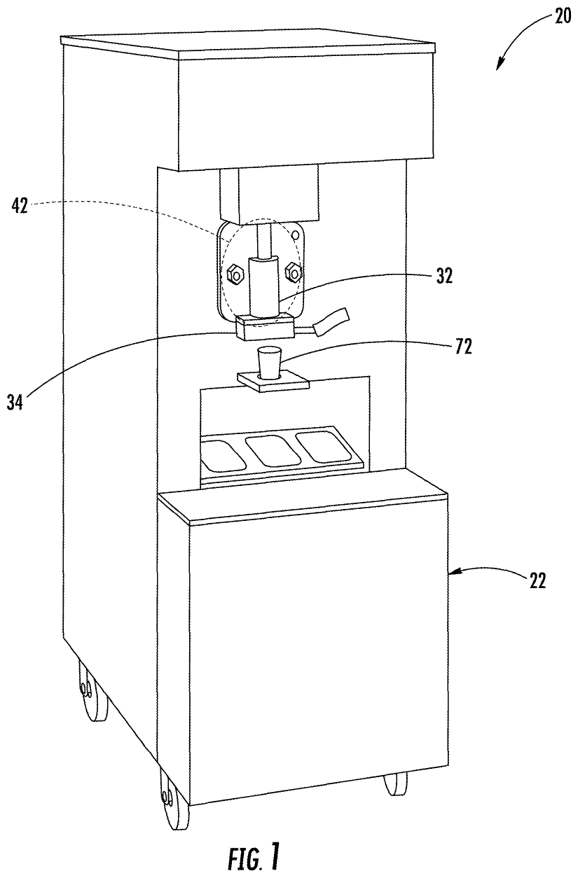

Referring to FIG. 1, a product dispensing machine 20 that prepares and dispenses a product for human consumption is illustrated. The dispensing machine 20 may be adapted to selectively dispense the product with two different consistencies both made from a common base product. In one example, the dispensed product may include an ice cream (e.g., soft served ice cream) and a shake both from a common base product. In another example, the dispensed product may include frozen yogurt and chilled yogurt both made from a common yogurt base product. In yet another embodiment, the dispensed product may include a beverage with a frozen, slush, consistency, and a chilled, liquid, consistency. It is further contemplated and understood that other products for human consumption may be applicable to the present disclosure.

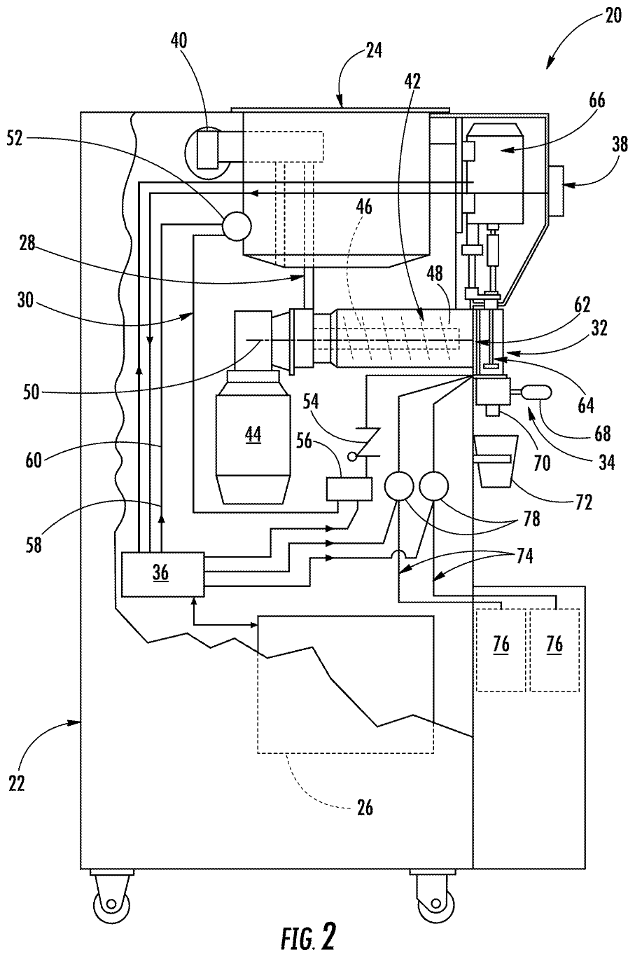

Referring to FIGS. 1 and 2, the product dispensing machine 20 may include a support structure 22 that may generally be a cabinet, a base product container 24, a refrigeration unit 26, a freeze circuit 28, a liquid circuit 30, a blending chamber assembly 32, a dispensing assembly 34, a controller 36, and a human interface 38. The base product container 24, the refrigeration unit 26, the controller 36, and the frozen and liquid circuits 28, 30 may general be housed within and supported by the cabinet 22. The blending chamber assembly 32, the dispensing assembly 34 and the human interface 38 may generally be mounted to a front side of the cabinet 22.

In the example of a product dispensing machine 20 that selectively prepares and serves ice cream and shakes, the freeze circuit 28 is adapted to receive the base product from the container 24 in liquid form and freeze the product to a frozen consistency for general storage. Upon a user demand for (as one example) a soft serve ice cream, and commanded via the user interface 38, a portion of the product in the frozen consistency (i.e., at about 16 to 18 degrees Fahrenheit) may flow through the blending chamber assembly 32 and dispensed through the dispensing assembly 34 for serving to a customer.

The liquid circuit 30 is adapted to receive the base product from the container 24 in liquid form, control and/or maintain the product at a controlled flow and temperature for placement of a portion of the product in a liquid consistency into the blending chamber assembly 32. Upon a user demand for a shake, and commanded via the user interface 38, a portion of the product in the frozen consistency is placed in the blending chamber assembly 32. The blending chamber assembly 32 then blends the portion in the frozen consistency with the portion in the liquid consistency, flows the blended product in shake form to the dispensing assembly, where it is then dispensed as a shake (e.g., at about 22 to 26 degrees Fahrenheit) for service to the customer.

The refrigeration unit 26 may be generally controlled by the controller 36, and may be adapted to maintain a predefined temperature of the base product stored in the container 24, may be adapted to freeze a portion of the base product within the freeze circuit 28, and may be adapted to maintain a predefined temperature of a portion of the base product within the liquid circuit 30. As is known by one skilled in the art, the refrigeration unit 26 may include a compressor, a condenser, and an evaporator that may generally be associated with the freeze circuit 28. Although not specifically illustrated, various configurations of the refrigeration unit 26 may be implemented to control the temperature of the product (e.g., chill the product) at various locations and at differing temperatures.

The freeze circuit 28 may include a product pump 40, a freezing cylinder 42, a movement device 44, and a beater 46. The beater 46 may be any kind of device capable of mixing the product into an appropriate consistency. Examples of a beater 46 may be include a paddle and/or a helical screw. The product pump 40 may be a gear pump mounted to the product container 24, and is adapted to deliver the base product from the container 24 to the freezing cylinder 42. The product pump 40 may be controlled by the controller 36 that may receive any variety of sensory inputs, and/or may operate based on direct sensory input indicating a need for more product in the freezing cylinder 42. The freezing cylinder 42 may be an integral part of an evaporator of the refrigeration unit 26, and generally defines the boundaries of a freezing chamber 48 that may be substantially cylindrical and centered along an axis 50. The mixer 46 may generally be spiraled and is driven for rotation along the axis 50 by the motion device 44 that may include an electric motor. Operation/rotation of the mixer 46 assists in the (at least partial) freezing of the product within the chamber 48 to produce and maintain the desired frozen consistency. Other examples of a product pump 40 may include a peristaltic pump and a piston pump. Alternatively, the product dispensing machine 20 may rely on gravity feed, thus may not require a pump at least for the main first frozen product.

The liquid circuit 30 is generally routed between the container 24 and the blending chamber assembly 32, and may include a product flow control device 52, a check valve 54, and a temperature device 56. The product flow control device 52 may be a gear pump supported by the cabinet 22, and may further be located and mounted to the container 24. The flow control device 52 may be controlled by the controller 36 (see arrow 58) that may receive any variety of sensory inputs, and/or, may operate based on direct sensory input that indicates a need for more product in a delivery conduit 60 of the liquid circuit 30. It is further contemplated and understood that one embodiment of the flow control device 52 may generally share the pump 40 of the freeze circuit 28 and may further include a downstream flow control valve (not shown) that operates off of at least one sensory input (e.g., flow and/or pressure).

The temperature device 56 may generally be connected to the conduit 60 and functions to maintain the product within the conduit at a predetermined temperature. The predetermined temperature is that established to achieve the desired consistency and/or viscosity of the shake to be served. More specifically, the predetermined temperature may be based in-part on the base product composition, the volumetric ratio of blended freeze and liquid portions of the base product, and the controlled temperature of the freeze portion. It is contemplated and understood that if the predetermined temperature within the conduit 60 is lower than the product temperature within the container 24, the temperature device 56 may generally be, or include, the refrigeration unit 26. If the predetermined temperature of the liquid product portion with the conduit 60 is higher than the base product temperature within the container 24, then the temperature device 56 may include a heating element.

The check valve 54 of the liquid circuit 30 is interposed in, or intersects, the conduit 60, and may be proximate to the blending chamber assembly 32 downstream of the temperature device 56. The check valve 54 functions to prevent reverse flow of the product from the blending chamber assembly 32 and into the conduit 60.

The blending chamber assembly 32, may include an inlet port for receiving the frozen product portion of the base product from the freeze circuit 28 (i.e., through a product dispensing door 62 located at an axial end of the freezing cylinder 42), and an inlet port for receiving the liquid product portion. The blending chamber assembly 32 may further include a mixer 64 for blending the product and an electric motor 66 for driving the mixer 64 that may be controlled by the controller 36.

The dispensing assembly 34 may generally be a shut-off valve having a handle 68 and a single nozzle 70 for dispensing the product in both an ice cream form and a shake form or consistency. The dispensing assembly 34 receives the prepared product from the blending chamber assembly 32 and flows it through the nozzle 70 into an awaiting container or cone 72 when open. Further details of both a blending chamber assembly and a dispensing assembly are disclosed in U.S. Pat. No. 8,402,781, issued Mar. 26, 2013, titled: Machine for Making Both Ice Creams and Shake, as is incorporated herein by reference in its entirety.

The product dispensing machine 20 may further include at least one auxiliary circuit 74 that may be a syrup circuit for adding flavor to the base product (i.e., two syrup circuits 74 illustrated). The syrup circuit 74 may include a container 76 and a pump 78 (e.g., gear pump) that may be controlled by the controller 36. In operation, a user may operate the user interface 38 requesting, for example, a particular flavor. An associated request signal is sent from the user interface 38 and to the controller 36. In-turn, the controller may output a command signal to the associated pump 78 for a particular flavor. The pump 78 operates to deliver an appropriate amount of syrup from the associated container 76 and into the blending chamber assembly 32. It is understood that the term ‘container’ may include a tank, a flexible bag, a tub, or any other open or closed storage device capable storing the product. It is further contemplated and understood that one or more of the containers 24, 76 may be an integral part of the machine 20 (i.e., within the machine cabinet), or may be remotely located.

The controller 36 may be an electronic controller and may further include a processor (e.g., microprocessor) that monitor and acts upon various operating parameters of the product dispensing machine. As previously described, the controller may be configured to receive requests from the user interface 38 in the form of electric signals, process the requests, and send command signals to various components to achieve the request. The controller 36 may be one controller or may be a multitude of controllers. In one example, selection between an ice cream product and a shake product may be in-part a mechanical or manual operation for ice cream, and an electrically automated operation for a shake. Some automated aspects of the product dispensing machine 20 may not be controlled or otherwise influenced by the controller 36, and instead may be directly implemented by sensory input and/or manual actuation.

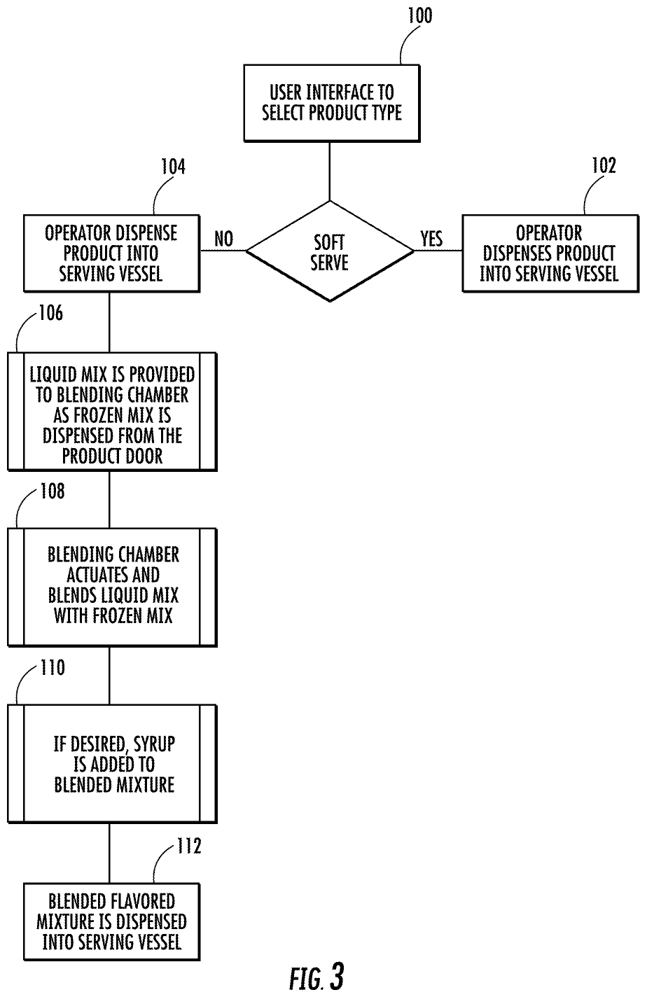

Referring to FIG. 3, a method of operating the product dispensing machine 20 includes at block 100, a user utilizing the user interface 38 to select a product type (e.g., soft serve ice cream or shake). At block 102, if a soft serve ice cream is selected the controller 36 may not require any action and the user may simply operate the dispensing assembly 34 to flow the product in an ice cream consistency into the container 32. At block 104, if a shake is selected, the user may not immediately operate the dispensing assembly 34 and instead, the shake selection may be sent to the controller 36 as an electric signal. At block 106, the controller 36 may send a command signal to the flow control device 52 of the liquid circuit 30 for delivery of a liquid portion of the base product to the blending chamber assembly 32. At block 108, the controller 36 may actuate the blending chamber assembly 32 thereby blending the liquid and frozen portions of the base product together. At block 110, and if desired, the user may, for example, through the interface 38 choose a syrup for a particular flavor. This selection is sent to the controller 36 and the controller may send a command signal to the pump 78 of the syrup circuit 74 to deliver the syrup to the blending chamber assembly 32. At block 112, and after sufficient blending, the user may then actuate the dispensing assembly 34 (i.e., open the nozzle 70) to deliver the shake product to the container 72.

Advantages and benefits of the present disclosure may include product flexibility (i.e., multiple products and combination of products may be served from a single freezing cylinder), a reduction in equipment cost, and a decrease in required equipment footprints. Other advantages may include fewer operating parts thus less parts to wear leading to improved unit reliability. Yet further, the product dispensing machine of the present disclosure may be cheaper and simpler to operate with less daily maintenance and simplified cleaning procedures.

While the present disclosure is described with reference to illustrated embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

What is claimed is:

1. A product dispensing machine comprising:
a container for storing a base product;
a freeze circuit constructed and arranged to extract a first portion of the base product from the container and substantially freeze the first portion into a first consistency;
a liquid circuit constructed and arranged to extract a second portion of the base product from the container;
a blending chamber assembly in fluid communication with the frozen and liquid circuits, and constructed and arranged to blend the first and second portions into a second consistency; and
a dispensing assembly in fluid communication with the blending chamber assembly, and constructed and arranged to selectively dispense the first portion in the first consistency, and the first and second portions in the second consistency.

2. The product dispensing machine set forth in claim 1 further comprising:
a refrigeration unit constructed and arranged to extract heat from the freeze circuit.

3. The product dispensing machine set forth in claim 2, wherein the refrigeration unit is constructed and arranged to control temperature of the base product in the container.

4. The product dispensing machine set forth in claim 2, wherein the freeze circuit includes a freezing cylinder defining a chamber in fluid communication between the container and the blending chamber assembly, and constructed and arranged to freeze the first portion via the refrigeration unit.

5. The product dispensing machine set forth in claim 4, wherein the freeze circuit includes a beater disposed in the freezing chamber for working the first portion.

6. The product dispensing machine set forth in claim 2, wherein the liquid circuit includes a pump for controlling the flow of the second portion to the blending chamber assembly.

7. The product dispensing machine set forth in claim 6, wherein the liquid circuit includes a temperature device configured to control the temperature of the second portion.

8. The product dispensing machine set forth in claim 2, wherein the liquid circuit includes a check valve for preventing flow of the base product from the blending chamber assembly back to the container.

9. The product dispensing machine set forth in claim 2 further comprising:
a controller constructed and arranged to control the refrigeration unit; and
a human interface constructed and arranged to select between the first and second consistencies of the base product for dispensing through the dispensing assembly.

10. The product dispensing machine set forth in claim 9, wherein the freeze circuit includes:
a freezing cylinder defining a chamber in fluid communication between the container and the blending chamber assembly and constructed and arranged to freeze the first portion via the refrigeration unit;
a beater disposed in the freezing chamber for working the first portion; and
a pump for flowing the first portion from the container to the freezing cylinder, wherein the pump is controlled by the controller.

11. The product dispensing machine set forth in claim 10, wherein the liquid circuit includes:
a flow control device for controlling the flow of the second portion to the blending chamber assembly;
a temperature device configured to control the temperature of the second portion in the liquid circuit, wherein the temperature device is controlled by the controller; and
a check valve for preventing flow of the base product from the blending chamber assembly and back to the container.

12. The product dispensing machine set forth in claim 1, wherein the base product is at least in-part a dairy product, the first consistency is a soft ice cream consistency, and the second consistency is a shake consistency.

13. The product dispensing machine set forth in claim 1 further comprising:
a second container for storing an additive product; and
an additive circuit constructed and arranged to flow the additive product from the second container and to the blending chamber assembly.

14. The product dispensing machine set forth in claim 13, wherein the additive product includes a syrup.

15. The product dispensing machine set forth in claim 1, wherein the dispensing assembly includes a single nozzle for dispensing both the first portion in the first consistency, and the first and second portions in the second consistency.

16. An ice cream dispensing machine comprising:
a container for storing an base product;
a freeze circuit constructed and arranged to extract a first portion of the base product from the container and substantially freeze the first portion into an ice cream consistency;
a liquid circuit constructed and arranged to extract a second portion of the base product from the container;
a blending chamber assembly in fluid communication with the frozen and liquid circuits, and constructed and arranged to blend the first and second portions into a shake consistency; and
a dispensing assembly in fluid communication with the blending chamber assembly, and constructed and arranged to selectively dispense the first portion in the ice cream consistency, and the first and second portions in the shake consistency through a common nozzle of the dispensing assembly.

17. The ice cream dispensing machine set forth in claim 16 further comprising:
a refrigeration unit; and
wherein the freeze circuit includes an evaporator of the refrigeration unit adapted to be a freezing cylinder defining a chamber in fluid communication between the container and the blending chamber assembly for freezing the first portion into the ice cream consistency.

18. The ice cream dispensing machine set forth in claim 17, wherein the liquid circuit includes a temperature device configured to control the temperature of the second portion.
